(19) United States
(12) Patent Application Publication
(10) Pub. No.: US 2025/0097665 A1
(43) Pub. Date: Mar. 20, 2025

(54) METHOD AND APPARATUS FOR CHATTING SERVICE

(71) Applicant: KAKAO CORP., Jeju-si (KR)

(72) Inventors: Soo Yeun JANG, Seongnam-si (KR); Su Min CHO, Seongnam-si (KR); Hae Yoon CHO, Seongnam-si (KR); Maria PARK, Seongnam-si (KR)

(21) Appl. No.: 18/888,052

(22) Filed: Sep. 17, 2024

(30) Foreign Application Priority Data
Sep. 19, 2023 (KR) 10-2023-0124790

(51) Int. Cl. H04W 4/021; G06F 3/0484; H04W 4/12

(52) U.S. Cl. CPC H04W 4/021; H04W 4/12; G06F 3/0484

(57) ABSTRACT

A chatting service method and apparatus is disclosed. A method of operating a server providing a chatting service corresponding to one or more themes, according to an embodiment, may include: receiving a message including area information through a chat room corresponding to a specific theme; providing a map interface for exposing information about the message to a terminal; determining an area range based on view manipulation information of the map interface received from the terminal; extracting message information corresponding to the area range; and providing the extracted message information through the map interface.

### CROSS-REFERENCE TO RELATED APPLICATIONS

This application claims priority under 35 USC § 119(a) to Korean Patent Application No. 10-2023-0124790 filed on Sep. 19, 2023, in the Korean Intellectual Property Office, the disclosure of which is incorporated by reference herein in its entirety.

### BACKGROUND

### Technical Field

The following description relates to a method and apparatus for a chatting service.

### Description of Related Art

The recent development of mobile smart devices has increased the use of online platform services for interacting with other users over a network. The online platform services for interacting with other users include, as representative examples, a social networking service (SNS) which provides an online platform for creating and consolidating social relationships through communication, information sharing, and networking among users, and an instant messaging service (IMS) which provides an online platform for real-time content communication between two or more users. These online platform services are providing, as communication using mobile devices increases, more various types of communication services in addition to one-to-one communication and multi-user communication with other users.

### BRIEF SUMMARY

According an embodiment, there is provided a method of operating a server providing a chatting service corresponding to one or more themes, the method including: receiving a message including area information through a chat room corresponding to a specific theme; providing a map interface for exposing information about the message to a terminal; determining an area range based on view manipulation information of the map interface received from the terminal; extracting message information corresponding to the area range; and providing the extracted message information through the map interface.

The extracting of the message information may include determining the message information to be extracted based on a level of the area range.

The extracting of the message information may include extracting a target message including area information corresponding to the area range; and extracting a file included in the target message.

The method may further include determining a representative file based on metadata of the file included in the target message and the area information included in the target message.

The determining of the representative file may include determining a candidate message from among target messages, based on whether the metadata of the file included in the target message matches the area information included in the target message; determining a representativeness score of the candidate message for at least one of the theme or the area range; and determining the representative file from among files included in the candidate message based on the representativeness score.

The providing of the extracted message information may include providing an interfacing object indicative of information about the representative file through the map interface.

The extracting of the message information may include extracting statistical information of the target message including the area information corresponding to the area range.

The providing of the extracted message information may include providing an interfacing object indicative of the statistical information of the target message through the map interface.

The extracting of the message information may include extracting a message written by an account of a specific type among target messages including the area information corresponding to the area range.

The view manipulation information may be generated based on at least one of an input that changes location information on a map displayed through the map interface; an input that changes a scale of the map displayed through the map interface; or an input that searches for a specific place through the map interface.

According to another embodiment, there is provided a method of operating a terminal using a chatting service corresponding to one or more themes, the method including: selecting a chat room corresponding to a specific theme; displaying a map interface for exposing information about messages transmitted through the selected chat room; transmitting, to a server, view manipulation information for determining an area range corresponding to the map interface; and displaying message information corresponding to the determined area range through the map interface.

The displaying of the message information may include displaying the message information based on a level of the determined area range.

The displaying of the message information may include displaying information about a file included in a message corresponding to the determined area range, through the map interface.

The displaying of the message information may include displaying statistical information of a message corresponding to the determined area range, through the map interface.

According to another embodiment, there is provided a server configured to provide a chatting service corresponding to one or more themes, the server including: one or more processors configured to receive a message including area information through a chat room corresponding to a specific theme; provide a map interface for exposing information about the message to a terminal; determine an area range based on view manipulation information of the map interface received from the terminal; extract message information corresponding to the area range; and provide the extracted message information through the map interface.

When extracting the message information, the one or more processors may be configured to determine the message information to be extracted based on a level of the area range.

The one or more processors may be configured to determine a representative file based on metadata of the file included in the target message and the area information included in the target message.

When extracting the message information, the one or more processors may be configured to extract statistical information of the target message including the area information corresponding to the area range.

According to another embodiment, there is provided a terminal using a chatting service corresponding to one or more themes, the terminal including: one or more processors configured to select a chat room corresponding to a specific theme; display a map interface for exposing information about messages transmitted through the selected chat room; transmit, to a server, view manipulation information for determining an area range corresponding to the map interface; and display message information corresponding to the determined area range through the map interface.

### BRIEF DESCRIPTION OF THE SEVERAL VIEWS OF THE DRAWINGS

The above and other features of certain embodiments of the present disclosure will be more apparent from the following detailed description, taken in conjunction with the accompanying drawings, in which:

FIG. 1 is a flowchart illustrating a method of operating a server providing a chatting service corresponding to one or more themes according to an embodiment;

FIG. 2 is a flowchart illustrating a method of operating a terminal using a chatting service corresponding to one or more themes according to an embodiment;

FIGS. 3A and 3B are diagrams illustrating example screens of an interface for selecting a chat room according to an embodiment;

FIG. 4 is a diagram illustrating a view manipulation input for determining an area range according to an embodiment;

FIG. 5 is a diagram illustrating an example screen of an interface for writing a message including area information according to an embodiment;

FIG. 6 is a diagram illustrating message information displayed through a map interface according to an embodiment;

FIG. 7 is a diagram illustrating an example screen of an interface for displaying a message in a chat room corresponding to a specific theme according to an embodiment; and

FIG. 8 is a diagram illustrating an example hardware configuration of a system for a chatting service corresponding to one or more themes according to an embodiment.

### DETAILED DESCRIPTION

The following detailed structural or functional description is provided only for the purpose of providing examples, and various alterations and modifications may be made to the examples. Here, the examples are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that, if one component is described as “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the disclosure of the present application and is not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components and a repeated description related thereto will be omitted.

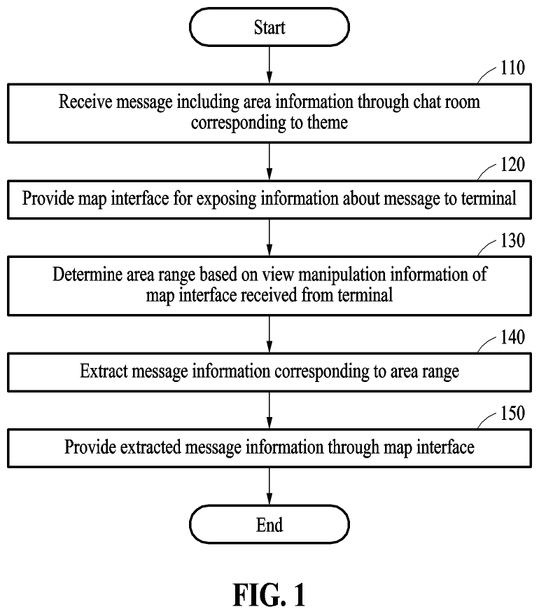

FIG. 1 is a flowchart illustrating a method of operating a server providing a chatting service corresponding to one or more themes according to an embodiment.

A server may provide a chatting service corresponding to one or more themes over a network. The chatting service may include a messaging service, and services related thereto, which enables a plurality of users to conduct a real-time chat by transmitting messages such as text messages, voice messages, media files, or the like, in real time over the network such as a wireless Internet or a wireless communication network.

The server may interwork with a web or application (or simply “app”) for the chatting service executed on a terminal to provide user interfaces (UI), functions, operations, services, or the like.

A user may use the chatting service provided by the server by executing, on the terminal, the web or app for the chatting service. The terminal may be any electronic device capable of installing and executing the web or app, for example, a computer, a portable computer, a wireless phone, a mobile phone, a smartphone, a personal digital assistant (PDA), a web tablet, a wearable device, or any other device. In this case, the terminal may receive services and/or content through an app or web installed and executed thereon. For example, the terminal may perform overall service-related operations such as, for example, service screen configuration, data input, data transmission and reception, data storage, or the like under the control of the app or web. For example, the terminal may process user interfacing or user interaction through a processor (or processors), and output or transmit results of the processing through an output device of the terminal.

The user may use the chatting service, using an account created by signing up for the chatting service or another service connected to the chatting service. The terminal of the user may refer to a terminal or device logged in with the account of the user.

According to an embodiment, a chatting interface may be provided to the terminal through the app or web for the chatting service. The chatting interface, which is an interface for functionality for transmitting and receiving messages for chatting, may include, for example, an interface that provides a function of transmitting messages through a chat room in which an account of at least one user participates and a function of displaying received messages. The chatting interface may correspond to the chat room, a virtual space in which the account of the at least one user participates and chatting between the participants occurs.

Referring to FIG. 1, a method of operating the server according to an embodiment may include operation 110 of receiving a message including area information through a chat room corresponding to a specific theme. The theme described herein may refer to a purpose, topic, category, concept, or keyword regarding the content of chats, and may include, for example, “Today's Weather,” “Fall Foliage Destinations,” “Neighborhood News,” “Baseball,” “Korea-Japan Game,” or the like. A chat room may be generated for a specific theme. For example, a first chat room corresponding to a first theme and a second chat room corresponding to a second theme may be generated, and the first chat room and the second chat room may correspond to distinct chat spaces.

A message transmitted through the chat room may include area information. The area information may include information indicative of an administrative division (e.g., state/province, city/county/district, town/township/village, etc.), an address of a specific place, or information indicative of a location such as global positioning system (GPS) coordinate information. For example, the area information may be included in the body of the message or appended to the message in the form of a tag. The area information included in the message may be determined by a (user) input from the user or may be determined by location information of the terminal.

In an embodiment, the method of operating the server may include operation 120 of providing a map interface for exposing information about the message to the terminal. The map interface may be used to display a map of a specific area range. The map interface may be used to display information (hereinafter “message information”) about the message received through the chat room corresponding to the specific theme. The message information displayed through the map interface is described below.

In an embodiment, the method of operating the server may include operation 130 of determining an area range based on view manipulation information of the map interface received from the terminal.

A view of the map interface may be controlled by a user input. The view of the map interface may refer to a view of a map screen output through the map interface onto the terminal of the user. For example, location information displayed through the map interface may be changed by a user input. For example, a scale of a map displayed through the map interface may be changed by a user input.

The view manipulation information, which is information directing to change the view of the map interface, may include at least one of the following: an input changing the location information on the map displayed through the map interface, an input changing the scale of the map displayed through the map interface, an input searching for a specific place through the map interface, and an input selecting an area entry from an area list. In response to the input changing the location information on the map, the view of the map interface may be changed to display a map corresponding to the changed location information. In response to the input changing the scale of the map, the view of the map interface may be changed to display a map corresponding to a smaller area or a map corresponding to a larger area. In response to the input searching for a specific place, the view of the map interface may be changed to display a map corresponding to the retrieved place. The input searching for a specific place may be entering a search word that specifies location information, which may include, for example, an input searching for a specific address, an input searching for a name of a specific area, an input searching for a business name, or the like. The input selecting an area entry from an area list may refer to an input selecting one or more entries from the area list including one or more areas as entries provided through the map interface. The view of the map interface may be changed to display a map corresponding to the selected entry.

Based on the location information on the map displayed through the map interface, the area range may be determined. The area range may be determined to be an area including the location information on the map displayed through the map interface. For example, in a case where the location information on the map displayed through the map interface corresponds to a partial area, for example, “Town C of District B of City A,” in an administrative division, the area range may be determined to be “Town C of District B of City A,” “District B of City A,” or “City A.”

In an embodiment, the method of operating the server may include operation 140 of extracting message information corresponding to the determined area range.

The message information corresponding to the area range may include information about a message including area information corresponding to the area range. The message including the area information corresponding to the area range may be referred to herein as a “target message.” For example, in a case where an area range is determined to be “District B of City A,” a message including, as area information, location information corresponding to “District B of City A” may correspond to a target message.

The message information, which is information about the message, may include at least one of the following: information about a sender of the message, the content of the message, a file (e.g., an image, a video, a document file, etc.) included in the message, and statistical information of the message.

In an embodiment, operation 140 of extracting message information may include extracting at least one message (or target message) including area information corresponding to an area range, and extracting a file included in the extracted at least one target message.

In an embodiment, the method of operating the server may include determining a representative file based on metadata of the file included in the target message and the area information included in the target message. The metadata of the file may include information indicating a location of the terminal at a time at which the file is generated on the terminal or at a time at which the file is stored on the terminal. The representative file may be selected from one or more files included in one or more target messages. For example, at least one file may be determined to be the representative file, based on the relevance between the metadata of the file and the area information included in the message.

In an embodiment, the operation of determining the representative file may include determining a candidate message from among extracted target messages based on whether metadata of a file included in an extracted target message and area information included in the extracted target message are matched. In this case, when location information indicated by the metadata of the file included in the target message and the area information included in the target message are matched, the target message may be determined to be the candidate message. Alternatively, when the location information indicated by the metadata of the file included in the target message is included in a determined area range, the target message may be determined to be the candidate message. Alternatively, when the determined area range is included in the location information indicated by the metadata of the file included in the target message, the target message may be determined to be the candidate message. Alternatively, when the determined area range and the location information indicated by the metadata of the file included in the target message are adjacent to each other (e.g., a distance between the determined area range and the location information indicated by the metadata of the file included in the target message is less than or equal to a threshold value), the target message may be determined to be the candidate message.

In an embodiment, the operation of determining the representative file may include determining a representativeness score of the candidate message for at least one of the specific theme or the area range, and determining the representative file from among files included in the candidate message based on the determined representativeness score. The representativeness score of the message may correspond to a measure of whether the candidate message is representative of the specific theme and/or the area range.

The representativeness score of the message may be determined based on at least one of the following: the relevance of a file included in the message to the specific theme, the relevance of the content of the message to the specific theme, the number of reactions to the message, the number of reactions (e.g., views, downloads, shares, replies, show reactions, etc.) to the file included in the message, a time at which the message is written, current location information of the terminal requesting the transmission of the message, profile information of the user writing the message, information indicating whether the message is a reported message, or the like.

For example, the relevance of the file included in the message to the theme may be a value related to a degree to which the content of the file included in the message corresponds to the theme. For example, in a case where the theme is a weather-related theme, for example, “Today's Weather,” a representativeness score of a message including a file (e.g., an image or video identifying the weather, a document file describing the weather, etc.) including the content about the weather may be determined to be a higher value than a representativeness score of a message including a file of other content.

For example, the relevance of the content of the message to the theme may be a value related to a degree to which the content of a text in the message corresponds to the theme. For example, in a case where the theme is a weather-related theme, for example, “Today's Weather,” a representativeness score of a message including a text (e.g., a text describing the weather) of the content about the weather may be determined to be a higher value than a representativeness score of a message including a text of other content.

For example, a reaction to a message may include viewing, sharing, copying, replying, and/or showing reactions (e.g., like, register as interesting, etc.) to the message. As the number of reactions to the message increases, the representativeness score of the message may be determined to be a higher value.

For example, a reaction to a file included in a message may include viewing, downloading, sharing, copying, and/or showing reactions (e.g., like, register as interesting, etc.) to the file included in the message. As the number of reactions to the file included in the message, a representativeness score of the message may be determined to be a higher value.

For example, as a time at which a message is written is closer to a current time, a representativeness score of the message may be determined to be a higher value.

For example, in a case where current location information of the terminal requesting the transmission of a message is included in the area range, a representativeness score of the message may be determined to be a higher value, than in other cases.

For example, profile information of a user who has written a message may include information identifying the user or indicating the characteristics of the user. The profile information of the user may include information about, for example, name, identification (ID), nickname, age, gender, residential area, primary residence, occupation, office, hobbies, reporting history, or the like of the user. In this example, a representativeness score of the message may be determined based on the relevance of the profile information of the user who has written the message to a specific theme and/or area range. For example, in a case where a residential area, a primary residence, or an office of the user is within the area range, a representativeness score of the message written by the user may be determined to be a higher value than a representativeness score of a message written by another user who is not relevant to the above. For example, in a case where a hobby or occupation of the user is related to the specific theme, a representativeness score of the message written by the user may be determined to be a higher value than a representativeness score of a message written by another user who is not relevant to the above.

For example, based on whether a message is a reported message, for example, in a case where the message has a history of being reported by other users or the content of the message has been written in violation of a rule, a representativeness score of the message may be determined to be a low value such that the message is excluded from the candidate message or a file included in the message is not selected as the representative file.

In an embodiment, operation 140 of extracting message information may include extracting statistical information of the message (or target message) including the area information corresponding to the area range. For example, the statistical information of the target message may include information indicative of the amount or number of target messages. The statistical information of the target message may include information indicative of the amount or number of messages for each of areas of a level lower than that of the area range. For example, in a case where the area range is determined to be “District B of City A,” the statistical information of the target message may include information indicative of the amount or number of messages for each of areas of a level “Town” included in “District B of City A.”

In an embodiment, operation 140 of extracting message information may include extracting a message written by an account of a specific type among messages (or target messages) including the area information corresponding to the area range.

Accounts of users subscribed to the chatting service may be classified into a plurality of types. For example, the types of accounts may include at least one of the following: an enterprise type, an advertiser type, an operator type, and a general type. An account of the enterprise type may correspond to an account set by a legal person or organization, rather than a natural person, as an entity. An account of the advertiser type may be an account registered for the purpose of providing advertisements through the chatting service. An account of the operator type may be an account set as an operator of a chat room. An account of the general type may be an account generated as a general user subscribes to the service.

Among the target messages, a message written by at least one of the enterprise type, the advertiser type, or the operator type may be extracted. For example, a message written by an account of the advertiser type or the operator type may be displayed differently from a message written by an account of the general type. How a message is displayed is described below.

In an embodiment, operation 140 of extracting message information may include determining message information to be extracted based on a level of the determined area range. The level of the area range may be classified based on the size or unit of an area included in the area range. For example, the level of the area range may be classified into a “country” level, a “state/province” level, a “city/county/district” level, and a “town/township/village” level, based on the unit of administrative division covered by the area range.

For example, in a case where the level of the area range is a first level (e.g., the “country” level), the message information to be extracted may be determined to be statistical information of the target message. Also, in a case where the level of the area range is a second level (e.g., the “state/province” level, the “city/county/district” level, or the “town/township/village” level), the message information to be extracted may be determined to be a representative file of the target message. By determining the message information to be extracted differently depending on the level, different message information may be provided through the map interface. In this case, information corresponding to the area range covered by the map displayed on the map interface may be provided.

In an embodiment, the method of operating the server may include operation 150 of providing the extracted message information through the map interface.

In a case where the representative file is extracted as the message information, operation 150 of providing the extracted message information may include providing an interfacing object indicative of information about the representative file through the map interface. The interfacing object indicative of the information about the representative file may be referred to herein as a first interfacing object. The first interfacing object may be displayed at a location corresponding to the representative file on a map displayed through the map interface. For example, location information corresponding to the representative file may correspond to information indicating a location of area information included in a representative message. For example, the location information corresponding to the representative file may be provided by providing the representative file through the first interfacing object indicating a location within a representative map interface. For example, the first interfacing object may be displayed at the location on the map corresponding to the message including the representative file. The location on the map corresponding to the message including the representative file may include a location corresponding to the area information in the message or a location of the terminal at the time the message has been written, on the map displayed through the map interface.

The message including the representative file may also be referred to herein as a representative message. According to an embodiment, a shape of the first interfacing object may be determined based on the number of messages including the same area information as the representative message, among messages received through the chat room corresponding to the specific theme. For example, at least one of the size, shape, color, or special effects of the first interfacing object may be determined based on the number of messages including the same area information as the representative message. For example, as the number of messages including the same area information as the representative message increases, the first interfacing object may be displayed to be larger.

When the representative file is extracted as the message information, operation 150 of providing the extracted message information may include providing content information of the representative message. For example, a text message included in the representative message may be displayed through the map interface.

When the statistical information of the target message is extracted as the message information, operation 150 of providing the extracted message information may include providing an interfacing object indicative of the statistical information of the target message through the map interface. The interfacing object indicative of the statistical information of the target message may also be referred to herein as a second interfacing object. The second interfacing object may be displayed at a location corresponding to the statistical information on the map displayed through the map interface. For example, the second interfacing object may be used to display the number of messages for each of areas of a level lower than the area range. The second interfacing object may display the number of target messages corresponding to each of the areas. The second interfacing object may be displayed at a location of each area on the map.

According to an embodiment, a shape of the second interfacing object may be determined based on the number of messages for each of areas of the level lower than the area range, among messages received through the chat room corresponding to the theme. For example, at least one of the size, shape, color, and special effects of the second interfacing object may be determined based on the number of messages for each of the areas. For example, as the number of messages for each of the areas increases, the second interfacing object may be displayed to be larger.

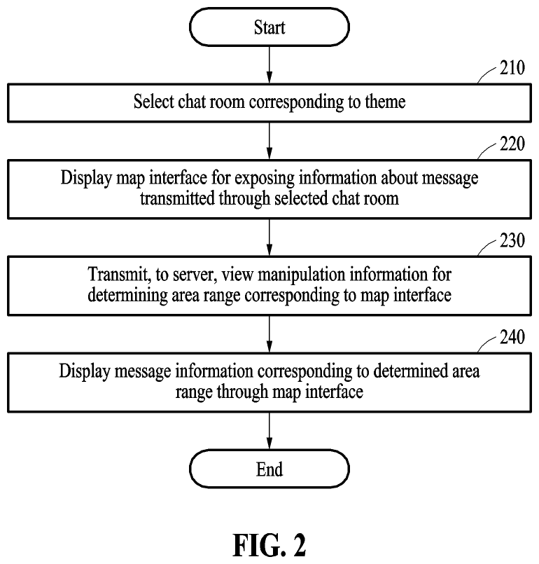

FIG. 2 is a flowchart illustrating a method of operating a terminal using a chatting service corresponding to one or more themes according to an embodiment.

Referring to FIG. 2, a method of operating the terminal according to an embodiment may include operation 210 of selecting a chat room corresponding to a specific theme, and operation 220 of displaying a map interface for exposing information about messages transmitted through the selected chat room. A user may select a chat room corresponding to a specific theme through a terminal that executes a web or app for a chatting service. The terminal may display a map interface corresponding to the selected chat room.

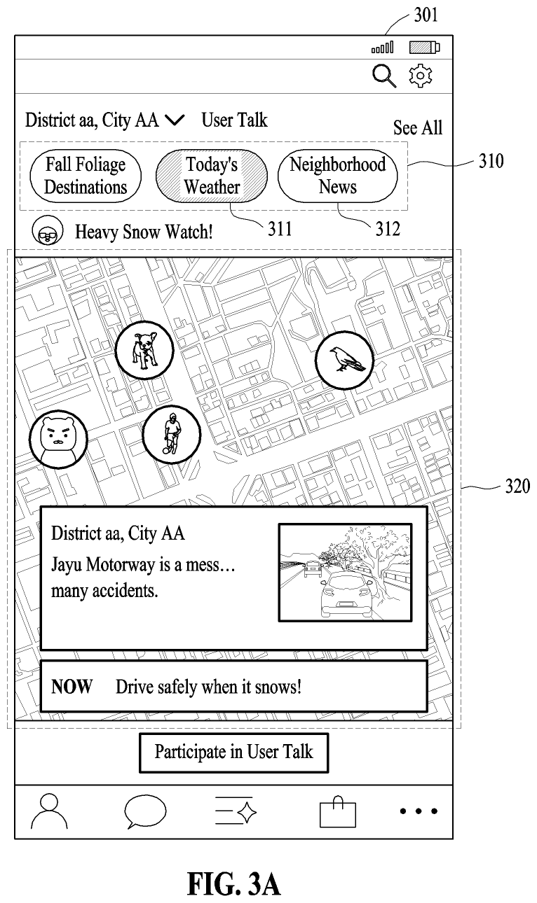

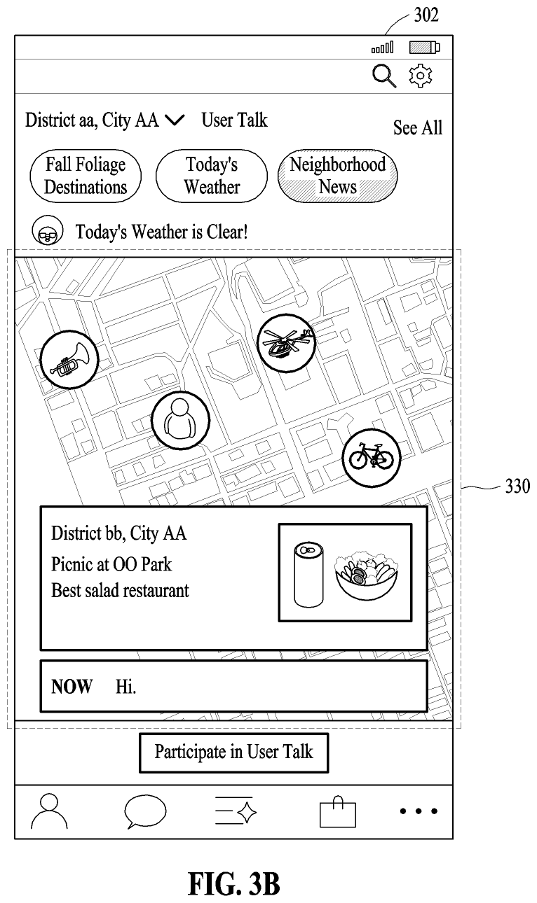

For example, referring to a screen 301 of FIG. 3A, an interface for selecting a chat room may be provided on a terminal executing a web or app for a chatting service. As described above, a chat room may correspond to a theme, and may be provided for each theme. The interface for selecting a chat room may include an interfacing object 310 indicating a theme corresponding to a created chat room. For example, a chat room corresponding to a theme “Today's Weather” may be selected by an input selecting an interfacing object 311 indicating the theme “Today's Weather.” When the chat room is selected, a map interface 320 may be displayed to display information about messages transmitted through the chat room.

The screen 301 may be switched to a screen 302 of FIG. 3B by an input selecting an interfacing object 312 indicating a theme “Neighborhood News.” Referring to the screen 302 of FIG. 3B, a map interface 330 of a chat room corresponding to the theme “Neighborhood News” may be displayed.

In an embodiment, a chat room corresponding to a specific theme may be selected also by an input that directly searches for a name of the theme or searches for a keyword related to the theme, in addition to the input that selects the interfacing object 310 indicating the theme.

In an embodiment, the method of operating the terminal may include operation 230 of transmitting, to a server, view manipulation information for determining an area range corresponding to the map interface. As described above, a view of the map interface may be controlled by a user input, and the view manipulation information may be information directing to change the view of the map interface.

The view manipulation information may include an input changing a scale of a map displayed through the map interface. For example, the input changing the scale of the map may include pinch-in and/or pinch-out inputs to pinch in and/or pinch out an area for which the map is displayed. In this case, the scale of the map may be reduced by the input pinching in the area for which the map is displayed, and the scale of the map may be expanded by the input pinching out the area for which the map is displayed. The scale of the map may determine the area range corresponding to the map interface.

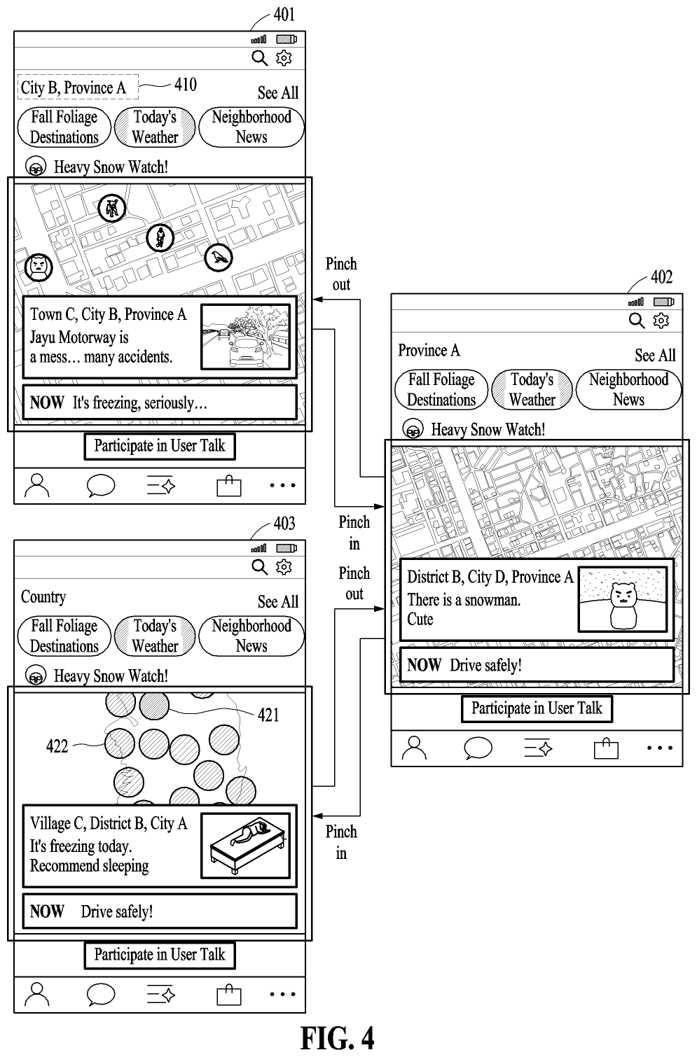

For example, referring to a screen 401 of FIG. 4, in a case where an area corresponding to “City B of Province A” is displayed on a map, an area range may be determined to be “City B of Province A.” The determined area range may be displayed through an area range display window 410. In this case, when a scale of the map is reduced by a pinch-in input onto the screen 401, and an area including a plurality of “cities” included in “Province A” is displayed on the map as shown on a screen 402, the area range may be determined to be “Province A.” When the scale of the map is reduced by a pinch-in input onto the screen 402, and an area including a plurality of “provinces” in a “country” is displayed on the map as shown on a screen 403, the area range may be determined to be “Country.” On the other hand, when the scale of the map is expanded by a pinch-out input onto the screen 403, and an area corresponding to “Province A” is displayed as shown on the screen 402, the area range may be determined to be “Province A.” When the scale of the map is expanded by a pinch-out input onto the screen 402, and the area corresponding to “City B of Province A” is displayed, the area range may be determined to be “City B of Province A.”

In addition, the view manipulation information may include an input changing location information on the map displayed through the map interface. For example, the location information on the map displayed through the map interface may be changed by an input dragging an area for which the map is displayed. For example, in a case where the location information on the map is changed from “Village C of City B of Province A” to “Village D of City B of Province A” by an input dragging an area for which the map is displayed, the area range may be determined to be “Village D of City B of Province A.”

The view manipulation information may include an input searching for a specific place through the map interface. In a case where a name or address of a specific place is retrieved through the map interface, the area range may be determined to be an area including the place. The map interface may be used to display a map of the area including the place. For example, in a case where the retrieved place is in “Village C of City B of Province A,” the area range may be determined to be “Village C of City B of Province A,” “City B of Province A,” or “Province A.” A level of the area range may be determined to be a predetermined level or the same level as a level of the area range corresponding to the map interface before the search.

In an embodiment, the method of operating the terminal may include operation 240 of displaying message information corresponding to the determined area range through the map interface. As described above, the message information corresponding to the area range may include information about a message including area information corresponding to the area range. The message including the area information corresponding to the area range may be referred to herein as a “target message.”

A message transmitted through a chat room may include area information. The message may be written to include the area information through an interface for writing the message. The area information in the message may be determined by location information of the terminal at a time the message is written or may be determined by location information input by a user writing the message.

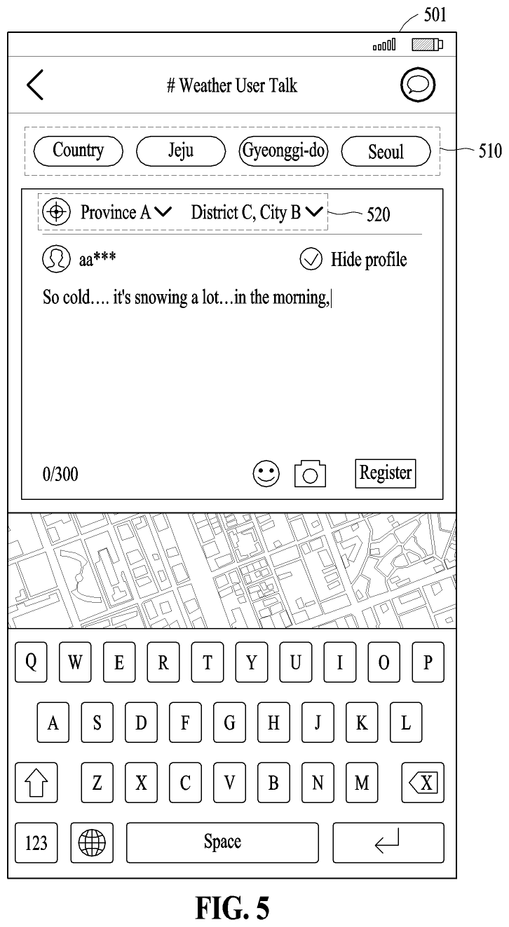

For example, referring to a screen 501 of FIG. 5, an interface for writing messages may include an input menu 510 for inputting area information in a message. The area information of the message may be determined by an input selecting an entry of a specific area from the input menu 510 of the area information of the message. For example, referring to the screen 501 of FIG. 5, the interface for writing messages may include an area information input window 520 for inputting area information of a message. In this case, information about a location input by the user into the area information input window 520 may be determined to be the area information of the message. Also, location information of the terminal at a current time may be automatically input into the area information input window 520.

In an embodiment, operation 240 of displaying the message information may include displaying information about a file included in the message corresponding to the determined area range through the map interface. As described above, the file displayed through the map interface may include a file selected as a representative file among files included in target messages.

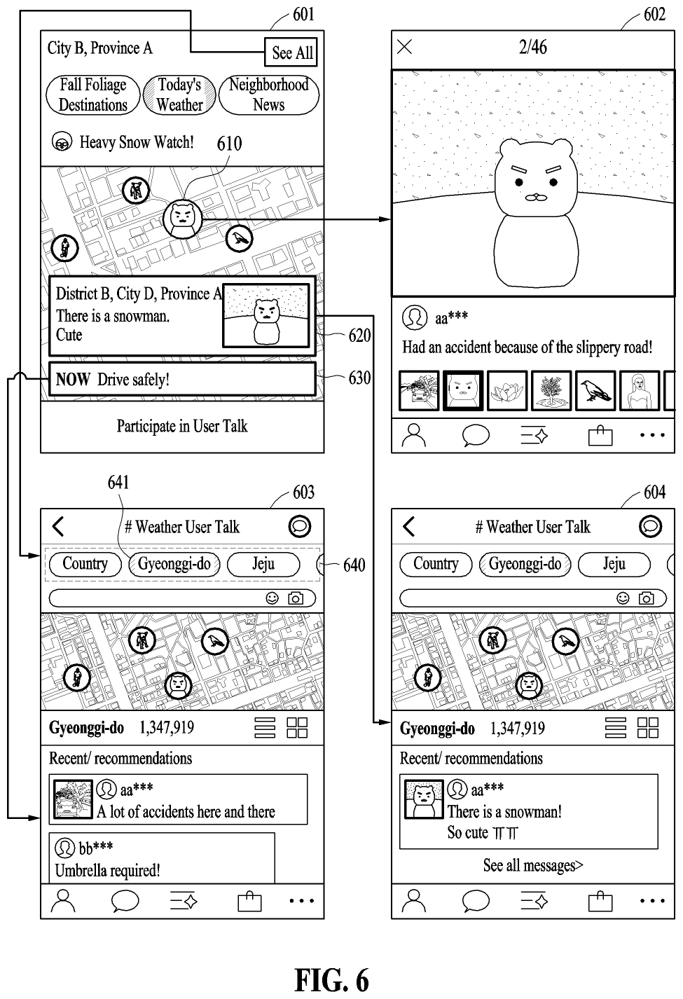

For example, referring to a screen 601 of FIG. 6, a map interface may include a first interfacing object 610 indicative of information about a representative file. In a case where the representative file is an image, the first interfacing object 610 may include an image of the representative file. The first interfacing object 610 may be displayed at a location on a map corresponding to a message including the representative file. The location on the map corresponding to the message may correspond to a location of area information included in the message. In this case, a shape of the first interfacing object 610 may be determined based on the number of messages including the same area information. For example, as the number of messages including the same area information increases, the first interfacing object 610 may be displayed to be larger. Alternatively, the shape of the first interfacing object 610 may be determined based on whether the first interfacing object 610 is selected. For example, when an input selecting the first interfacing object 610 is received, the selected first interfacing object 610 may be displayed to be larger than other unselected first interfacing objects.

When the input selecting the first interfacing object 610 is received, the screen 601 may be switched to a detailed page screen 602 of the representative file. Referring to the screen 602, a full image of the representative file displayed on the first interfacing object 610 and information about the message including the representative file may be displayed. The information about the message displayed on the detailed page screen 602 may include at least one of the following: the content of the message, information (e.g., name, ID, nickname, etc.) about an author of the message, a message write time of the message at which the message has been written, and reaction information about reactions (e.g., the number of setting “like,” the number of setting “interesting,” comments, etc.) to the message.

The map interface may include a display window 620 for displaying summary information of the message corresponding to the selected first interfacing object 610. The summary information of the message may include at least one of the following: the representative file included in the message, a text message included in the message, the information about the author, and the reaction information. The screen 601 may be switched to a detailed page screen 604 of the message by an input selecting the display window 620 for displaying the summary information of the message. Referring to the screen 604, full content of the message and the information about the message displayed on the display window 620 may be displayed. The full content of the message displayed on the detailed page screen 604 may include the text message and/or file included in the message. The information about the message displayed on the detailed page screen 604 may include at least one of the following: the content of the message, the information (e.g., name, ID, nickname, etc.) about the author of the message, the message write time, and the reaction information (e.g., the number of setting “like,” the number of setting “interesting,” comments, etc.) about the message.

Referring to the screen 601, the map interface may include a display window 630 for displaying a message written by an account of a specific type. For example, the account of the specific type may be an account of a type other than a general type, such as, for example, an account of at least one of an advertiser type or an operator type. The message displayed through the display window 630 may correspond to a message that is specified as a representative message by the account of the specific type in connection with a notice or theme. The screen 601 may be switched to a screen 603 displaying a list of all messages in the chat room by an input selecting the display window 630. Referring to the screen 603 displaying the list of all the messages, all the messages transmitted through the chat room may be displayed. For example, the screen 603 displaying the list of all the messages may display an area corresponding to the message displayed through the display window 630 on the list of all the messages. For example, the screen 603 displaying the list of all the messages may include a list of messages generated by filtering all the messages transmitted through the chat room by area information. For example, referring to the screen 603, an interfacing object 640 for selecting area information for such message filtering may be provided, and a list of messages filtered as messages including “Gyeonggi-do” or including area information corresponding to “Gyeonggi-do” may be provided by an input selecting an interfacing object 641 corresponding to the area information of “Gyconggi-do.”

Referring again to FIG. 2, operation 240 of displaying the message information may include displaying statistical information of the message corresponding to the determined area range through the map interface. As discussed above, statistical information of a target message may include information indicative of an amount or number of target messages.

For example, referring to the screen 403 of FIG. 4, the map interface may include a second interfacing objects 421 and 422 indicative of statistical information of a message. The second interfacing objects 421 and 422 may display information about the number of target messages for each of areas of a low level corresponding to an area range. For example, in a case where the area range is determined to be “Country,” second interfacing objects 421 and 422 corresponding to areas of a “City/Province” level included in the area range of “Country” may display information about the respective numbers of target messages for the respective areas. For example, the second interfacing object 421 corresponding to “Seoul” may display information about the number of messages including “Seoul” as area information among messages transmitted through a chat room corresponding to a specific theme. Also, the second interfacing object 422 corresponding to “Sejong” may display information about the number of messages including “Sejong” as area information among the messages transmitted through the chat room corresponding to the theme. Depending on the number of messages, the respective shapes of the second interfacing objects 421 and 422 may be determined differently. For example, in a case where the number of messages including “Seoul” as the area information is greater than the number of messages including “Sejong” as the area information, the second interfacing object 421 corresponding to “Seoul” may be displayed to be darker in color than the second interfacing object 422 corresponding to “Sejong,” or the second interfacing object 421 corresponding to “Seoul” may be displayed to be larger in size than the second interfacing object 422 corresponding to “Sejong.”

Referring again to FIG. 2, operation 240 of displaying the message information may include displaying the message information based on a level of the determined area range. For example, in a case where the level of the area range is a first level (e.g., a “Country” level), the message information to be extracted may be determined to be statistical information of the target message.

For example, referring again to FIG. 4, in a case where a level of an area range is a first level (e.g., a “Country” level) as shown on the screen 403, message information to be extracted may be determined to be statistical information of a target message. In this case, a map interface may be used to display the second interfacing objects 421 and 422 that indicate the statistical information of the target message. On the other hand, in a case where the level of the area range is a second level (e.g., a “City/Province” level, a “City/County/District” level, or a “Town/Township/Village” level) as shown on the screens 401 and 402, the message information to be extracted may be determined to be a representative file of the target message. In this case, the map interface may be used to display a first interfacing object indicating information about the representative file.

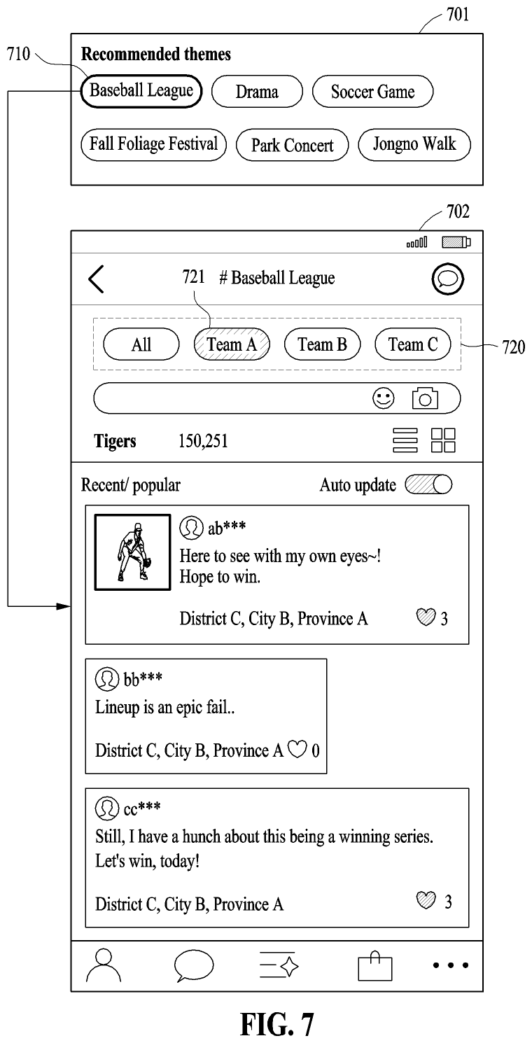

FIG. 7 is a diagram illustrating an example screen of an interface for displaying a message in a chat room corresponding to a specific theme according to an embodiment.

According to an embodiment, a message in a chat room corresponding to a specific theme may be appended with theme-specific category information. For example, the theme-specific category information may include at least one of area information or detailed category information corresponding to the theme. That is, the category information appended to the message may be determined to be of different types depending on themes.

Referring to a screen 701 of FIG. 7, a “Baseball League” theme 710 may be selected from among themes corresponding to a chat room. The screen 701 may be switched to a screen 702 of an interface of the chat room corresponding to the “Baseball League” theme 710 by an input selecting the “Baseball League” theme 710.

Referring to the screen 702, a list of messages transmitted through a chat room corresponding to a “Baseball League” theme (e.g., the “Baseball League” theme 710) may be displayed. The messages in the chat room corresponding to the “Baseball League” theme may include team names of a “Baseball League” as detailed category information. The list of the messages in the chat room corresponding to the “Baseball League” theme may include a list of messages generated by filtering all the messages transmitted through the chat room by the detailed category information. An interfacing object 720 for selecting the detailed category information for such message filtering may be provided, and a list of messages filtered as messages including category information corresponding to “Team A” may be provided by an input selecting an interfacing object 721 corresponding to area information corresponding to “Team A.”

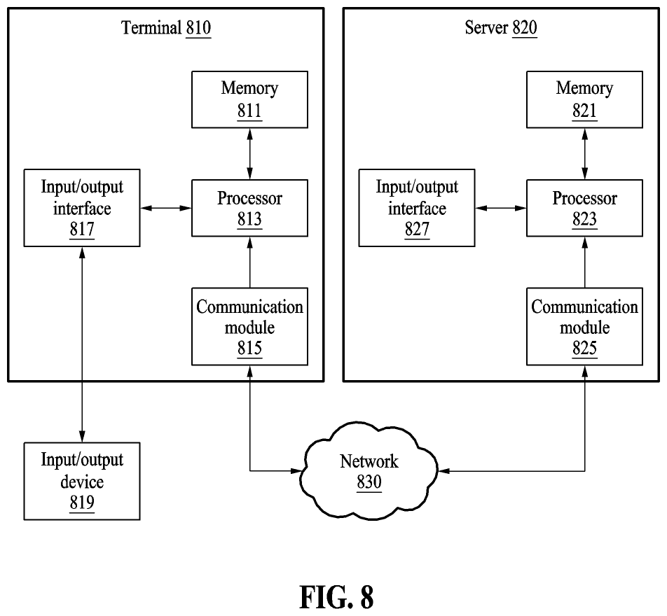

FIG. 8 is a diagram illustrating an example hardware configuration of a system for a chatting service corresponding to one or more themes according to an embodiment.

Referring to FIG. 8, a system according to an embodiment may include a terminal 810 and a server 820 connected through a network 830.

In an embodiment, the terminal 810 may be a mobile terminal implemented as a computer device. For example, the terminal 810 may communicate with the server 820 and/or other electronic devices over the network 830 using wireless or wired communication methods.

In an embodiment, the server 820 may be implemented as a computer device or a plurality of computer devices configured to communicate with the terminal 810 and/or other servers over the network 830 to provide commands, code, files, content, services, or the like. The communication methods may include, as non-limiting examples, a communication method using a communication network (e.g., a mobile communication network, wired Internet, wireless Internet, a broadcast network) included in the network 830 and a short-range wireless communication method for communication between devices. The network 830 may include, for example, at least one of networks such as a personal area network (PAN), a local area network (LAN), a campus area network (CAN), a metropolitan area network (MAN), a wide area network (WAN), a broadband network (BBN), and the Internet.

In an embodiment, the server 820 may provide a file for installing an application (or app) on the terminal 810 connected through the network 830. In this case, the terminal 810 may install the application (e.g., an app for a chatting service) using the file provided by the server 820. In addition, under the control of an operating system (OS) and at least one program (e.g., a browser or installed application) included in the terminal 810, the terminal 810 may access the server 820 to receive services or content provided by the server 820. For example, when the terminal 810 transmits a service request message to the server 820 over the network 830 under the control of the application, the server 820 may transmit a code corresponding to the service request message to the terminal 810, and the terminal 810 may configure and display a screen according to the code under the control of the application to provide content to a user.

In an embodiment, the terminal 810 and the server 820 may include memories 811 and 821, processors 813 and 823, communication modules 815 and 825, and input/output interfaces 817 and 827, respectively.

In an embodiment, the processors 813 and 823 may perform at least one of the operations described above with reference to FIGS. 1 through 7. For example, the processor 813 may perform at least one of the operations of the terminal 810 using a chatting service corresponding to one or more themes described above with reference to FIG. 2, and the processor 823 may perform at least one of the operations of the server 820 providing a chatting service corresponding to one or more themes described above with reference to FIG. 1. The processors 813 and 823 may be configured to process instructions from a computer program by performing basic arithmetic, logic, and input/output operations. The instructions may be provided to the processors 813 and 823 through the memories 811 and 821 or the communication modules 815 and 825.

The memories 811 and 821 may each be a computer-readable recording medium, which may be a volatile memory or non-volatile memory. In an embodiment, the memories 811 and 821 may store information for a chatting service corresponding to one or more themes described above with reference to FIGS. 1 through 7. For example, the memory 821 may store user account information of a user subscribed to the chatting service and chat room information corresponding to the themes.

In an embodiment, the memory 811 may include code for an app or web for a chatting service that is installed and executed on the terminal 810 by files provided by the server 820 over the network 830.

In an embodiment, the memory 821 may store a program in which the operations for the chatting service described above with reference to FIGS. 1 through 7 are implemented.

In an embodiment, the communication modules 815 and 825 may provide functionality for the terminal 810 and the server 820 to communicate with each other over the network 830 and may provide functionality for them to communicate with other electronic devices or other servers.

For example, a request generated by the processor 813 of the terminal 810 according to the program code for the app or web for the chatting service stored in a recording device such as the memory 811 may be transmitted to the server 820 over the network 830 under the control of the communication module 815.

For example, control signals, commands, content, files, or the like provided under the control of the processor 823 of the server 820 may be received by the terminal 810 through the communication module 815 of the terminal 810 through the communication module 825 and the network 830.

The input/output interfaces 817 and 827 may each be a means for interfacing with an input/output device 819. For example, the input device may include a device such as a keyboard, a mouse, or the like, and the output device may include a device such as a display for displaying a communication session of an application. For another example, the input/output interface 817 may be a means for interfacing with a device such as a touchscreen, in which functions for input and output are integrated into one. For example, the processor 813 of the terminal 810 may display, on a display through the input/output interface 817, a service screen or content configured using data provided by the server 820, when processing instructions from a computer program loaded into the memory 811. An input received from the user through the input/output device 819 may be provided in the form processible by the processor 813 of the terminal 810 through the input/output interface 817.

In an embodiment, the terminal 810 and the server 820 may include other components not shown in FIG. 8. For example, the terminal 810 may be implemented to include at least some of the input/output device 819 described above or may further include other components such as a transceiver, a GPS module, a camera, various sensors, a database (DB), or the like.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a server providing a chatting service corresponding to one or more themes, the method comprising:
receiving a message comprising area information through a chat room corresponding to a specific theme;
providing a map interface for exposing information about the message to a terminal;
determining an area range based on view manipulation information of the map interface received from the terminal;
extracting message information corresponding to the area range; and
providing the extracted message information through the map interface.

2. The method of claim 1, wherein the extracting of the message information comprises:
determining the message information to be extracted based on a level of the area range.

3. The method of claim 1, wherein the extracting of the message information comprises:
extracting a target message comprising area information corresponding to the area range; and
extracting a file comprised in the target message.

4. The method of claim 3, further comprising:
determining a representative file based on metadata of the file comprised in the target message and the area information comprised in the target message.

5. The method of claim 4, wherein the determining of the representative file comprises:
determining a candidate message from among target messages, based on whether the metadata of the file comprised in the target message matches the area information comprised in the target message;
determining a representativeness score of the candidate message for at least one of the theme or the area range; and
determining the representative file from among files comprised in the candidate message based on the representativeness score.

6. The method of claim 4, wherein the providing of the extracted message information comprises:
providing an interfacing object indicative of information about the representative file through the map interface.

7. The method of claim 1, wherein the extracting of the message information comprises:
extracting statistical information of a target message comprising area information corresponding to the area range.

8. The method of claim 7, wherein the providing of the extracted message information comprises:
providing an interfacing object indicative of the statistical information of the target message through the map interface.

9. The method of claim 1, wherein the extracting of the message information comprises:
extracting a message written by an account of a specific type among target messages comprising area information corresponding to the area range.

10. The method of claim 1, wherein the view manipulation information is generated based on at least one of:
an input that changes location information on a map displayed through the map interface;
an input that changes a scale of the map displayed through the map interface; or
an input that searches for a specific place through the map interface.

11. A method of operating a terminal using a chatting service corresponding to one or more themes, the method comprising:
selecting a chat room corresponding to a specific theme;
displaying a map interface for exposing information about messages transmitted through the selected chat room;
transmitting, to a server, view manipulation information for determining an area range corresponding to the map interface; and
displaying message information corresponding to the determined area range through the map interface.

12. The method of claim 11, wherein the displaying of the message information comprises:
displaying the message information based on a level of the determined area range.

13. The method of claim 11, wherein the displaying of the message information comprises:
displaying information about a file comprised in a message corresponding to the determined area range, through the map interface.

14. The method of claim 11, wherein the displaying of the message information comprises:
displaying statistical information of a message corresponding to the determined area range, through the map interface.

15. A non-transitory computer-readable storage medium storing instructions that, when executed by one or more processors, cause the one or more processors to perform the method of claim 1.

16. A server configured to provide a chatting service corresponding to one or more themes, the server comprising:
one or more processors configured to:
receive a message comprising area information through a chat room corresponding to a specific theme;
provide a map interface for exposing information about the message to a terminal;
determine an area range based on view manipulation information of the map interface received from the terminal;
extract message information corresponding to the area range; and
provide the extracted message information through the map interface.

17. The server of claim 16, wherein, for extracting the message information, the one or more processors are configured to:
extract a target message comprising area information corresponding to the area range; and
extract a file comprised in the target message.

18. The server of claim 17, wherein the one or more processors are configured to:
determine a representative file based on metadata of the file comprised in the target message and the area information comprised in the target message.

19. The server of claim 16, wherein, for extracting the message information, the one or more processors are configured to:
extract statistical information of the target message comprising the area information corresponding to the area range.

20. A terminal using a chatting service corresponding to one or more themes, the terminal comprising:
one or more processors configured to:
select a chat room corresponding to a specific theme;
display a map interface for exposing information about messages transmitted through the selected chat room;
transmit, to a server, view manipulation information for determining an area range corresponding to the map interface; and
display message information corresponding to the determined area range through the map interface.
